(19) United States
(12) Patent Application Publication
(10) Pub. No.: US 2006/0210851 A1
(43) Pub. Date: Sep. 21, 2006

(54) Fuel cell power generating system with learning control

(76) Inventors: Masahiro Komachiya, Tokyo (JP); Motoo Futami, Tokyo (JP); Yasuyuki Arimitsu, Hiroshima (JP); Hiroshi Yatabe, Hiroshima (JP); Yoshihide Kondo, Hiroshima (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/559,079

(22) PCT Filed: Jun. 2, 2004
(86) PCT No.: PCT/JP04/07985

§ 371 Date: Apr. 14, 2006

(30) Foreign Application Priority Data
Jun. 3, 2003 (JP) 2003-157739

(51) Int. Cl. H01M 8/04; H01M 8/06

(52) U.S. Cl. 429/23; 429/19

(57) ABSTRACT

A time zone when the operation pattern is obtained with a high learning convergence and a time zone when such an operation pattern cannot be obtained are set in advance. In the case where a significant difference develops between a target operation pattern and an actual load pattern, it is possible to accurately determine whether the operation is to be continued without changing the operation pattern or the operating conditions such as the hydrogen production amount should be changed in accordance with the actual load pattern. As a result, based on the scheduled operation with a predetermined operation pattern, the operation can be easily corrected in accordance with the complicated load change in home applications.

### TECHNICAL FIELD

The present invention relates to a technical field dealing with a power system using a fuel cell and a method of operation thereof. In particular, the present invention relates to a fuel cell power generating system suitable for home use.

### BACKGROUND ART

In a power system with a fuel cell, or especially in a home-use fuel cell power generating system, hydrogen constituting a material is difficult to supply or store, and therefore a method of generating power by producing hydrogen on site is under study. The endothermal reaction of a catalyst is mainly used for producing hydrogen, and therefore heat is required to be supplied to the reaction portion for efficient hydrogen production. On the other hand, in view of the fact that it is difficult to operate the fuel cell in such a manner as to consume 100% of hydrogen supplied, it is desirable to recover the hydrogen energy left without being used for power generation.

With these facts as a background, a method is generally known in which a hydrogen production unit has a combustor and the residual hydrogen in the anode exhaust gas of the fuel cell is burned as a fuel with air. The heat generated by combustion is supplied to the endothermal reaction for hydrogen production. By the heat capacity of the system, however, the response may be delayed. For this reason, some time length is often required to start the fuel production unit or to switch the hydrogen production amount.

A solution to this problem is either a method in which the hydrogen production method itself is uniquely designed or a method in which the hydrogen production unit is started, the hydrogen production amount is switched and the operation is stopped in an operation pattern predetermined in a manner allowing for the delay. The present invention described in detail below is intended for the latter method, and therefore it is explained.

In operating a fuel cell power generating system by switching the hydrogen production amount in a predetermined operation pattern, the operation pattern is required to be set in accordance with the actual required load pattern in advance. Especially in a home-use fuel cell power generating system, the load pattern is complicated and not constant, and therefore, the operation pattern is required to be determined in advance with some learning control or corrected while in operation.

As an example, Patent Document 1 deals with a fuel cell system in which the reforming fuel amount of the hydrogen production unit is set and the hydrogen production amount is switched periodically in at least one of daily, weekly and yearly cycles as indicated by the load power consumption.

As another example, Patent Document 2 describes a fuel cell system in which the hydrogen production amount of the hydrogen production unit is regulated based on the load prediction information thereby to follow the load change. In this fuel cell system, a preset operation pattern (operation plan) is corrected based on the calendar information, presence/absence of a person or the weather/meteorological information.

The acquisition of a fuel cell power generating system having a satisfactory load following characteristic without unique design for improving the response of the hydrogen production unit requires the scheduled operation and the correction based on the operation pattern as described above. Then, in the case where one hour is required to start the hydrogen production unit, for example, the system is adapted to start one hour before the morning time when the load is required. Also, during the daytime zone attended by no person, the hydrogen production amount can be reduced to save waste, while the hydrogen amount is increased by the time when some person returns home in the evening. In this way, the response delay can be met.

Patent Document 1: JP-A-2002-184441

Patent Document 2: JP-A-11-31521

The scheduled operation with a predetermined operation pattern, however, poses the problem that it is difficult to correct the operation in accordance with the actual load change.

Assume, for example, that an operation pattern is determined based on the result of learning that the required load increases after a person returns home in the evening. In spite of this, the person may happen to come home later for the reason of his/her job. In such a case, although the hydrogen production amount of the hydrogen production unit is increased in advance, the increased hydrogen is not used and directly returned to and burned in the combustor of the hydrogen production unit for lack of the load. This wastes the hydrogen produced and reduces the efficiency. In the case where the return hydrogen amount increases so much due to an unexpected load change and the temperature of the combustor or the hydrogen production unit sharply increases, the whole system is stopped as an emergency by a safety mechanism.

With the fuel cell power generating system described in Patent Document 1, the operation pattern is determined periodically in at least one of daily, weekly and yearly cycles indicated by the load power consumption. These periods are not more than pseudo ones, and therefore the same pattern is not accurately repeated. The pattern change described above, therefore, cannot be easily followed.

In the fuel cell power generating system described in Patent Document 2, in contrast, the hydrogen production amount of the hydrogen production unit is regulated based on the load prediction information, and therefore, the ability to follow the load change finely can be expected. Nevertheless, this requires the acquisition of the detailed load prediction information in advance. In the aforementioned case, for example, the fact that the person will return home later for the reason of his/her job is required to be given in advance as some information, which is actually difficult. Especially, the home-use fuel cell power generating system encounters the problem that the load pattern is complicated and not constant.

### DISCLOSURE OF INVENTION

The present invention has been achieved in view of the problem described above. The present invention takes the following two points into consideration: (1) In determining the operation pattern by learning, the convergence of the learning is not always unsatisfactory; (2) Simple and frequent changes caused by the early or late home-coming time or the presence or absence of a person lead to a deteriorated convergence. The convergence of learning is high with a gradual change, and therefore other changes are intentionally separated. This separation is required to be easy to carry out. Thus, a method has been conceived in which a time zone when the convergence of learning is low is designated in advance.

In the case where the learned operation pattern undergoes an unexpected change such as in the home-coming time which can be predicted to some degree, the particular change should be followed separately from the existing learning pattern. As for minor occasional changes, on the other hand, they should not be individually followed in detail, and the overage or shortage should be compensated by the storage battery or the system power. By doing so, the total system merit may be achieved taking the delay of the hydrogen production unit into account. As described above, a time zone where the learning convergence is so low as to have a large effect not negligible is set thereby to distinguish predictable and unpredictable cases from each other.

According to the present invention, there is provided a fuel cell power generating system comprising a fuel cell, a power conversion means for controlling and retrieving the current from the fuel cell, a hydrogen production unit for supplying hydrogen to the fuel cell, a load detection means for detecting the required power generation amount of the fuel cell, and a means for controlling at least one of the hydrogen production amount of the hydrogen production unit and the power output amount of the fuel cell in according to an operation pattern predetermined on daily basis, wherein a specified time zone when the load change is predicted is set in the operation pattern, and based on the required power generation amount detected by the load detection means, the hydrogen production amount for the specified time zone is switched in priority over the operation pattern.

Also, there is provided a fuel cell power generating system in which in the case where the operation is different by a predetermined value or more from the pattern required from the load detected by the load detection means, the difference is learned and reflected in the operation pattern for the next and subsequent days. Further, according to another aspect, there is provided a fuel cell power generating system in which a predetermined time zone where the learning is difficult to converge is set in advance, and in the case where the operation pattern and the load pattern are different from each other in the particular time zone, the hydrogen production amount is switched based on the required power generation amount detected by the load detection means in priority over the operation pattern.

With the fuel cell power generating system described above, a time zone when the operation pattern of high convergence characteristic is obtained by learning and other time zones are set in advance. In the case where a significant difference develops between a target operation pattern and an actual load pattern, it can be positively determined whether the operation should be continued without changing the operation pattern or the operation should be changed in accordance with the actual load pattern.

Also, the provision of the predetermined time zone on daily basis facilitates the absorption of the effect of the daily pseudo-periodical load change often observed in a home load pattern or the like. According to still another aspect, there is provided a fuel cell power generating system in which the learning weight is changed between the time zone in which the learning is difficult to converge and the other time zone, so that the daily operation pattern described above is corrected by learning.

In this fuel cell power generating system, the learning weight is determined in such a manner that the operation pattern is not considerably changed by a single change during the predetermined time zone subjected to frequent changes. As a result, the operation pattern of a high convergence can be obtained by learning. At the same time, since the learning is used also for the time zone subjected to frequent changes, a reference operation pattern can be changed against the tendency of the home-coming time to be early or late.

According to yet another aspect of the invention, there is provided a fuel cell power generating system in which the frequency of occurrence of the difference between the operation pattern and the load pattern is calculated at predetermined time intervals, and with reference to the frequency of occurrence, the set range of the predetermined time zone when the learning is difficult to converge is additionally registered or the registration thereof is canceled. Also, there is provided a fuel cell power generating system comprising a control mechanism for outputting an internal alarm by detecting the approach of a system fault condition such as an abnormal temperature of the hydrogen production unit, wherein upon determination that the alarm is attributable to the difference between the operation pattern and the load pattern, the predetermined time interval set based on the time of alarm is additionally registered in the predetermined time zone when the learning is difficult to converge. In this fuel cell power generating system, the predetermined time zone can be automatically corrected and regulated in accordance with the actual load change.

According to a further aspect, there is provided a fuel cell power generating system for smoothing and setting, at predetermined time intervals, the high-frequency component of the power load pattern detected by the load detection means, the system further comprising a power storage means such as a secondary battery collaborating with the fuel cell, wherein the high-frequency component of the power load pattern detected by the load detection means is accommodated by the discharge from the power storage means.

In this fuel cell power generating system, the operation pattern is corrected by learning in accordance with the smoothed power load pattern, and thus the correcting operation by learning high in convergence is made possible. Also, the high-frequency component of the load removed by the smoothing operation is accommodated by use of the power storage means such as a secondary battery for storing the extraneous portion of the fuel cell power generation in advance.

With a home-use fuel cell power generating system using the fuel cell power generating system according to the present invention described above, the load change can be steadily followed, and therefore both the system utilization rate and the operation efficiency are improved.

According to the present invention, there is provided a fuel cell power generating system comprising a fuel cell, a power conversion means for retrieving by controlling the current from the fuel cell, a hydrogen production unit for supplying hydrogen to the fuel cell, a load detection means for detecting the required power generation amount of the fuel cell, and a means for selecting a predetermined operation pattern and thereby controlling at least one of the hydrogen production amount of the hydrogen production unit and the power output amount of the fuel cell during a predetermined time zone. In this power generating system, the selection of the operation pattern can be carried out during a preset specified time zone when a load change is predicted.

### BRIEF DESCRIPTION OF THE DRAWINGS

FIG. 1 is a graph showing an example of the operation unique to a fuel cell power generating system according to a first embodiment of the invention.

FIG. 2 is a graph showing an example of the operation of a fuel cell power generating system according to a second embodiment of the invention.

FIG. 3 is a flowchart showing a control flow and an automatic setting method for a time zone when the learning is difficult to converge according to the first and second embodiments of the invention.

FIG. 4 is a flowchart showing an automatic setting method for a time zone when the learning is difficult to converge according to a third embodiment of the invention.

FIG. 5 is a diagram for explaining the process of filtering the detected load for setting the basic operation pattern.

FIG. 6 is a diagram showing a system configuration with the collaboration of the power storage means such as the secondary battery according to a fourth embodiment of the invention.

FIG. 7 is a schematic diagram showing an example of the case in which the fuel cell power generating system according to the invention is used as a stationary distribution power supply arranged in each home.

### BEST MODE FOR CARRYING OUT THE INVENTION

Embodiments of the invention are explained in detail below with reference to the drawings. An explanation is made first mainly about an example of the operation unique to the fuel cell power generating system according to the present invention. Then, a method for implementing the system is explained as an embodiment, and finally, an application is described. As a basic system configuration, an explanation is made about a fuel cell power generating system comprising a fuel cell, a power conversion means for controlling and retrieving the current from the fuel cell, a hydrogen production unit for supplying hydrogen to the fuel cell and a load detection means for detecting the required power generation amount of the fuel cell.

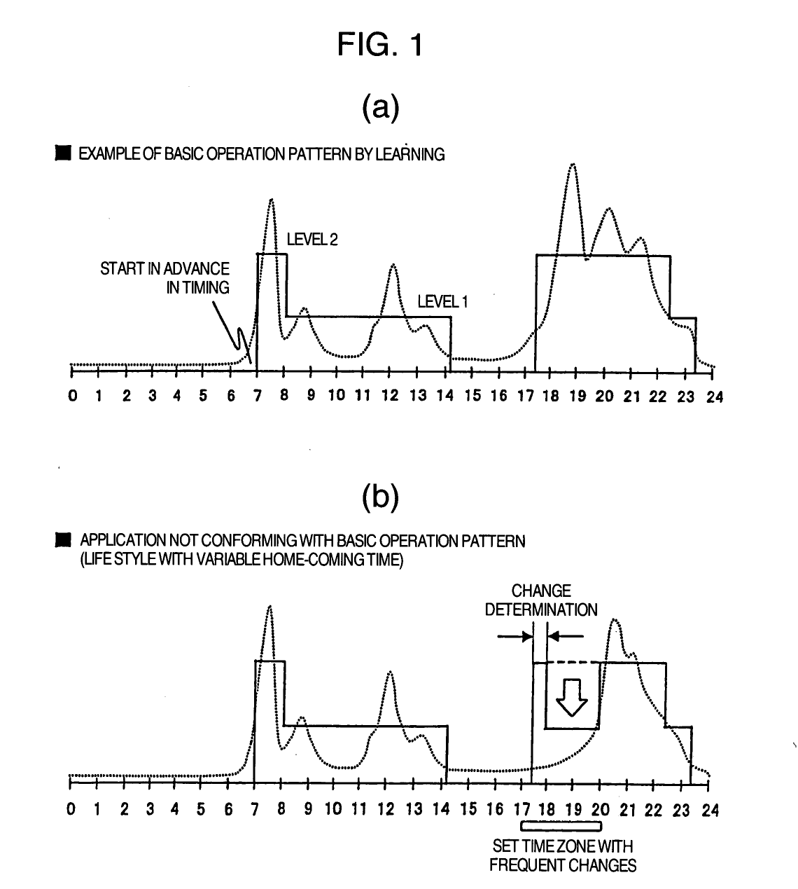

With reference to FIGS. 1(a), (b), an example of the operation unique to the fuel cell power generating system according to a first embodiment of the invention is explained. In FIGS. 1(a), (b), the abscissa represents the lapse of a time in a day, and the ordinate an example of the average load change (dotted line) and a target hydrogen production amount (solid line) obtained by learning. The hydrogen production amount changes with the output, and therefore the solid line can be regarded as a target output of the system. The target hydrogen production amount is assumed to be set to two stages of levels 1 and 2. Although the setting of each level changes stepwise, the actual hydrogen production unit is unable to start and respond instantaneously.

In view of the fact that the change in the target value (operation pattern) is known, however, the response delay of the hydrogen production unit can be avoided by presetting the starting timer of the hydrogen production unit to reach, for example, output level 2 at 7:00. The aforementioned operation pattern is used as a target value including this prediction.

Incidentally, the basic operation pattern is determined in advance in daily cycles, for example, and in the case where the operation pattern is different by a predetermined value or more from the load pattern detected by the load detection means, can be updated on daily basis to the operation pattern for the next and subsequent days to reflect the load change by learning.

FIG. 1(a) shows an example (solid line) of the basic operation pattern by learning. FIG. 1(b), on the other hand, shows an application not conforming with the basic operation pattern. An example is explained in which the home-coming time is late on some days and early on other days. To facilitate the understanding, a load change somewhat different from the actual life pattern is taken as an example. FIG. 1(a) shows a case in which the home-coming time is early, and the load is started at about 17:00 in the evening. The basic operation pattern described above can be considered to have been learned by the result for a month in which the home-coming time is early on many days.

For the days on which the home-coming time is late, on the other hand, the load is assumed to be started at about 19:00. In the case where the operation on the basic operation pattern is continued, extraneous hydrogen continues to be produced during the two hours from 17:00 to 19:00 undesirably from the viewpoint of efficiency. Also, the protracted increase in the combustion amount of anode off-gas in the hydrogen production unit may lead to an abnormal temperature of the hydrogen production unit.

In view of this, in FIG. 1(b), the period from 17:00 to 20:00 is set as a time zone when the load changes frequently, and in the case where the load is not increased as expected by the basic operation pattern during this time zone, the hydrogen production amount is reduced from level 2 to level 1 through a change determination. In the change determination, the start time of the two loads are distinguished based on the magnitude of the average load for a predetermined time from the starting time point of the predetermined time zone.

As described above, a predetermined time zone during which the learning is difficult to converge is set in advance, and in the case where the operation pattern and the load pattern are different from each other during this time zone, the hydrogen production amount is switched based on the required power generation amount detected by the load detection means in priority over the operation pattern.

The predetermined time can be set by the user or preset in the factory. As explained sequentially below, the time zone setting may be changed by learning in accordance with the actual occurrence of load change. Also, the predetermined time zone can be set over a long period of time according to the calendar or the like. In the case where the predetermined time zone is set in daily cycles, the change linked especially to the daily life in the home-use fuel cell system can be readily met. In this case, the comparatively gentle seasonal change in load pattern can be accommodated by changing the basic operation pattern by normal learning.

One of the features of the present invention lies in that in the case where the operation pattern and the load pattern are different from each other during the predetermined time zone mentioned above, the hydrogen production amount is switched based on the required power generation amount detected by the load detection means in priority over the operation pattern. Specific switching methods include: (1) a method in which the basic operation pattern is switched to another operation pattern in accordance with the load pattern change; and (2) a method in which the operation itself is changed from the scheduled operation to the following operation to follow the actual load pattern.

According to the first embodiment shown in FIG. 1, the former method is carried out in such a manner that upon and after the change determination, the operation is performed in accordance with another pattern prepared in advance. The control operation is facilitated by application of this method to the change during the period from the evening to the time to sleep which is comparatively easy to patternize. In the case where a plurality of operation patterns are assumed during the predetermined time zone described above, a particular pattern to which the operation is to be switched can be determined based on the magnitude of the load at a predetermined time point or the load values at designated different time points.

In the case where the load change during the predetermined time zone is complicated and not easy to patternize, the operation is preferably switched to the load following operation as in the latter method. According to the embodiment shown in FIG. 1, upon and after the change determination, the next target hydrogen production amount is determined at predetermined time intervals based on the load change detected by the load detection means. A particular predetermined time interval at which the target value is switched depends on the magnitude of response of the hydrogen production unit used. The load following operation may be performed only for a predetermined time from the switching command or may be continued from the time point when the command is received until the end of the predetermined time zone when the learning is difficult to converge.

In the unique operation of the fuel cell power generating system according to the first embodiment of the invention, the predetermined time zone when the learning is difficult to converge is set separately in advance. In this way, a safe, efficient system operation becomes possible against simple but comparatively frequent load changes caused by the early or later home-coming time or the presence or absence of a person. Also, in the case where the predetermined time zone is set in daily cycles, the changes linked to the daily life can be easily accommodated in the home-use fuel cell system.

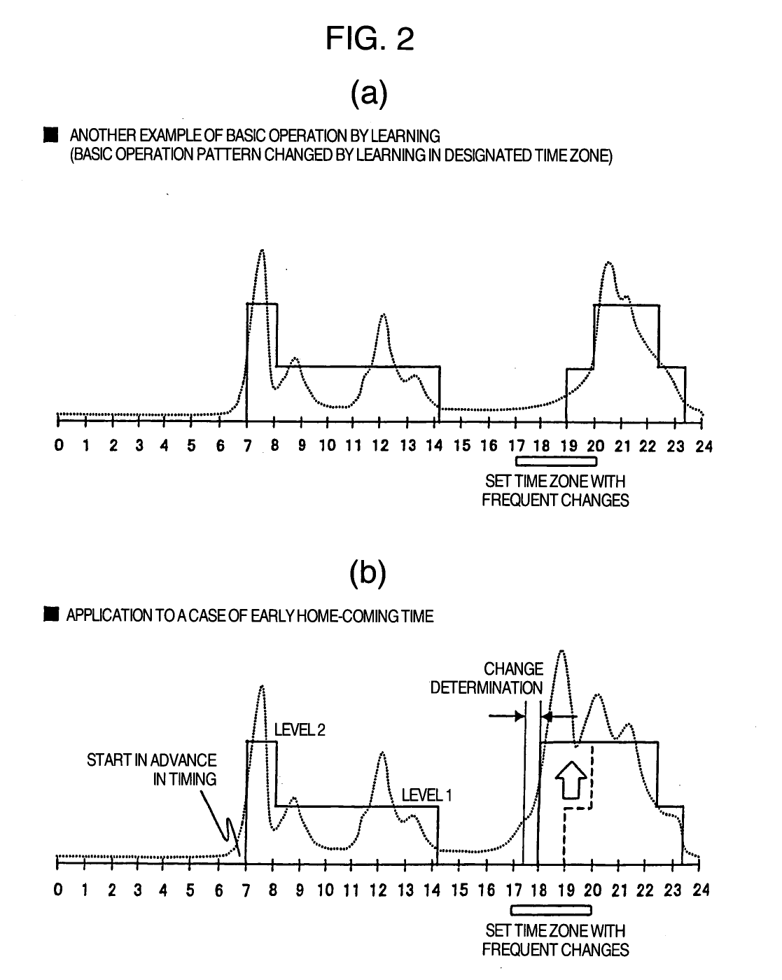

With reference to FIGS. 2(a), (b), an example of operation of the fuel cell power generating system according to a second embodiment of the invention is explained. In the case of FIGS. 1(a), (b), a basic operation pattern is determined for an assumed month in which the home-coming time is early on many days. For the month in which the home-coming time is late on many days, on the other hand, the basic operation pattern should be changed. On the day when the home-coming time is early, the load is started at about 17:00, while the load is started at about 19:00 on the day when the home-coming time is late.

In FIG. 2(a), the basic operation pattern is determined based on the day when the home-coming time is late. In FIG. 2(b), in contrast, like in the example of FIG. 1, the period from 17:00 to 20:00 is set as a time zone when the load frequently changes, and in the case where the load is increased more than expected from the basic operation pattern during this time zone, the hydrogen production amount is increased to level 2 through the change determination. A specific method is the same as the example shown in FIG. 1.

The basic operation pattern is changed by learning as in the normal learning control. In the case under consideration, however, it should be noted that the basic operation pattern is changed by learning during the predetermined time zone. This is by reason of the fact that this predetermined time zone is extracted as such during which the learning is difficult to converge. In other words, during this time zone, the satisfactory result cannot be expected by the same learning as the normal learning.

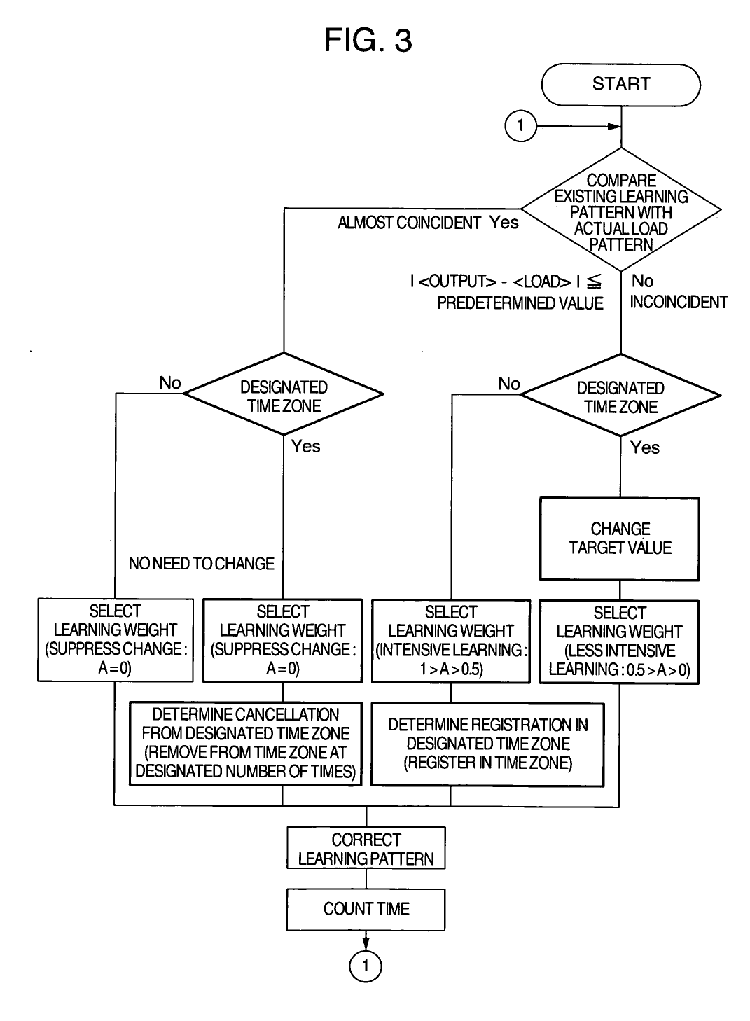

In view of this, according to the present invention, the learning is carried out less intensively than normal during the predetermined time zone. A more specific method is explained with reference to FIG. 3. According to this method, the basic operation pattern shown in FIG. 1, with which the operation may be started, can be changed securely by learning for any month in which the home-coming time is late on many days. As a result, the operation pattern can be switched to the form shown in FIG. 2(a).

The fuel cell power generating system according to the second embodiment of the invention described above so operates that in the case where the operation pattern and the load pattern are different from each other in the predetermined time zone, the hydrogen production amount is switched based on the required power generation amount detected by the load detection means in priority over the basic operation pattern. At the same time, the learning weight is differentiated between the time zone when the learning is difficult to converge and the other time zone thereby to correct the operation pattern by learning on daily basis. In this way, the load change during the predetermined time zone can be securely reflected in the basic operation pattern for the next and subsequent days.

Especially during the aforementioned time zone when the change is so frequent that the learning is difficult to converge, the learning weight is determined in such a manner that the operation pattern is not changed greatly by a single change. Thus, an operation pattern stable against changes can be selected by the simple method of setting a time zone.

FIG. 3 shows a control flow and a method of automatically setting a time zone when the learning is difficult to converge according to the first and second embodiments. The following explanation is made with reference to this control flow. First, the output power based on the operation pattern learned is compared with the actual power load change to determine whether a significant change exists between the two. This determination process evaluates the difference between the absolute values of the two thereby to determine, for example, that a difference exists in the case where the evaluation is larger than a predetermined value and no difference exists in the case where the evaluation is not more than the predetermined value. The values compared may be those at a specified time point. In the case where the control flow is repeated at predetermined time intervals, however, the average value for the time intervals can be employed. In the case where a complicated load pattern of the home load or the like is involved, a high-frequency value smoothed in advance may be used as explained later.

Next, an explanation is made about a case in which the operation pattern learned and the actual load change have a significant difference, and the time point at which the difference is recognized is included in the aforementioned time zone when the learning is difficult to converge. In this case, first, the operation pattern is switched by reference to the actual load. This is because of the determination that the actual load change is given priority over the predetermined operation pattern during the particular time zone. The operation pattern can be switched, for example, in the way explained with reference to FIG. 1.

After that, the change in the operation pattern is processed by learning. As explained with reference to FIG. 2, during the time zone when the change is so great that the learning is difficult to converge, however, a single change resulting in a great change in the operation pattern undesirably causes the loss of stability. For this reason, the learning weight should be determined at a low level. In the case under consideration, a simple method described below is conceived as an example.

Specifically, Equation 1 is introduced. In Equation 1, “Digitizing [ . . . ]” indicates the digitization to facilitate the processing of the value in parenthesis [ ]. Character A designates a parameter corresponding to the learning weight. As long as A is zero, the target output assumes a value determined by the original operation pattern. In the case where A is 1, on the other hand, the target output is determined not by the operation pattern but by the actual load. In the case where A is between 0 and 1, the target output assumes a value intermediate 0 and 1. If A is set between 0 and 0.5, the weight of the actual load is smaller than the weight of the learning pattern, and therefore the learning weight can be determined in such a manner that the operation pattern is not changed considerably by a single change. Using the target output thus determined as an operation target value for the same time point on the next day, the operation pattern can be corrected and learned.
Target output after change=Digitizing [A×Output commensurate with actual load+(1−A)×Output determined by learning pattern] (1)

In the aforementioned example, a specific value commensurate with the conditions as a learning weight is selected for each control interval. This value can be changed, however, in accordance with the frequency of an event developing a significant difference between the operation pattern learned and the actual load change. In this case, the number of times the event occurs per time zone can be determined and stored separately as an example.

On the day lacking an event, the number of times of occurrence can be reduced correspondingly. The selection of the learning weight A during the time zone is changed according to the frequency of occurrence. In the case where 0<A<0.5, for example, the value is incremented by 0.1 for each event occurrence from an initial value 0.1 up to 0.4 as an upper limit. Then, the learning during the time zone in which a significant difference is liable to occur between the operation pattern learned and the actual load change can be gradually intensified.

Assume that the season when the home-coming time is early transfers to the season when the home-coming time is late, for example. The value is changed carefully in the transient period, the change is quickly grasped by adding to A after the switching operation, and the operation pattern is maintained by reducing A after the operation pattern is stabilized upon complete switching operation. The learning weight A can be selected not necessarily by changing the frequency of occurrence but generally by the function of the frequency of occurrence.

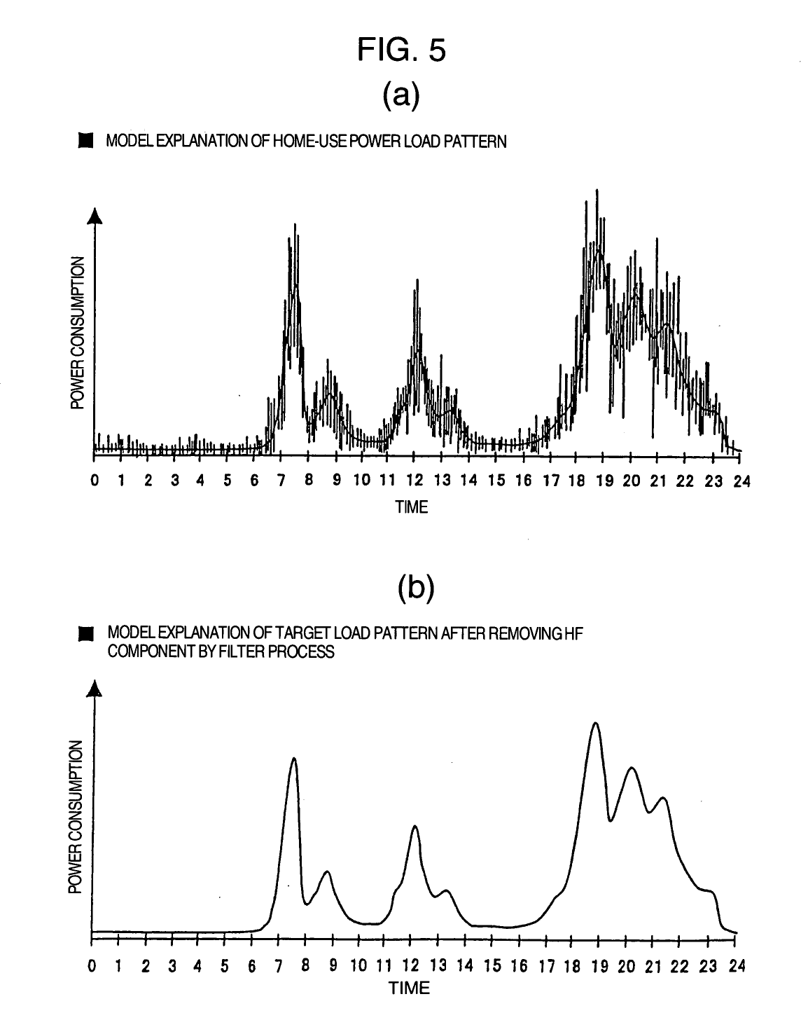

Next, an explanation is given about a case in which although the operation pattern learned and the actual load change have a significant difference, the time point when the particular difference is recognized is included in the time zone when the learning is not difficult to converge. In this case, the time zone prevails when the learning converges with comparative ease. Therefore, the target value (operation pattern) is not changed for each change of the actual load, but the prevailing operation pattern is maintained, while the learning and correction are carried out with normal weight. In the example shown in FIG. 5, the suppression of learning is not specifically required and therefore the learning is carried out in the range of 0.5<A<1.

The learning weight A of a value at which the learning converges well is selected in accordance with the feature of the load change involved. After that, it is determined whether the particular time zone is registered in a designated time zone or not. Specifically, in the case where the convergence of learning which has thus far been considered comparatively high actually continues the increasing tendency of change with the arrival of a given season, for example, the frequency of an event developing a significant difference between the operation pattern learned and the actual load change is increased.

In view of this, the frequency of occurrence of the event is referred to at each control interval, and in the case where the frequency of occurrence exceeds a predetermined value, the particular time zone is registered anew in a designated time zone. The total number of times of occurrence is used, for example, as the frequency of occurrence. After registration, the particular number of occurrences is reset, or in the absence of a significant difference between the operation pattern learned and the actual load change, the number is subtracted to zero.

In the case where a comparatively large change tends to occur unexpectedly, though less frequently, a considerably long time is required before registration in the designated time zone, and therefore the learning weight A is set to a slightly smaller value not to alter the operation pattern greatly with a single change, or altered as a function of the frequency of occurrence as described above.

Next, an explanation is given about a case in which there is no significant difference between the operation pattern learned and the actual load change and the time point when the difference is recognized is included in the time zone when the learning is difficult to converge. In this case, for lack of a significant difference between the operation pattern learned and the actual load change, the operation pattern is not required to be positively changed. The operation pattern change can be prevented by setting the learning weight A to zero. The learning weight A may alternatively be set to a sufficiently small value other than zero. Also, in the case where the difference from the operation pattern hardly occurs in spite of the designation of the time zone in which the learning is difficult to converge, the setting is improper and canceled as the designation time.

The determination of cancellation can be made only after the absence of a significant difference between the operation pattern learned and the actual load change continues for at least a predetermined number of times (predetermined number of days). Alternatively, depending on the feature of the load change involved, the determination can be made by considering whether the coincidence and incoincidence between the operation pattern and the actual load is repeated or not.

Next, an explanation is given about a case in which there is no significant difference between the operation pattern learned and the actual load change and the time point when the difference is recognized is not registered in the time zone when the learning is difficult to converge. In this case, for lack of a significant difference between the operation pattern learned and the actual load change, the operation pattern is not required to be changed positively. The operation pattern can be prevented from being changed by setting the learning weight A to zero. The learning weight A may be reduced to a sufficiently small value instead of zero. Also with regard to the registration and cancellation in the predetermined time zone, no change is required in this case. The series of process described above can be repeated through a predetermined time count.

In the control flow and the method of automatically setting a time zone when the learning is difficult to converge according to the first and second embodiments of the invention described above, the frequency of occurrence of a difference between the operation pattern and the load pattern is calculated at predetermined time intervals, and by reference to the frequency of occurrence, the range of setting the predetermined time zone when the learning is difficult to converge is automatically registered additionally or the registration thereof canceled. In this way, the optimal setting can be maintained in accordance with the actual load change.

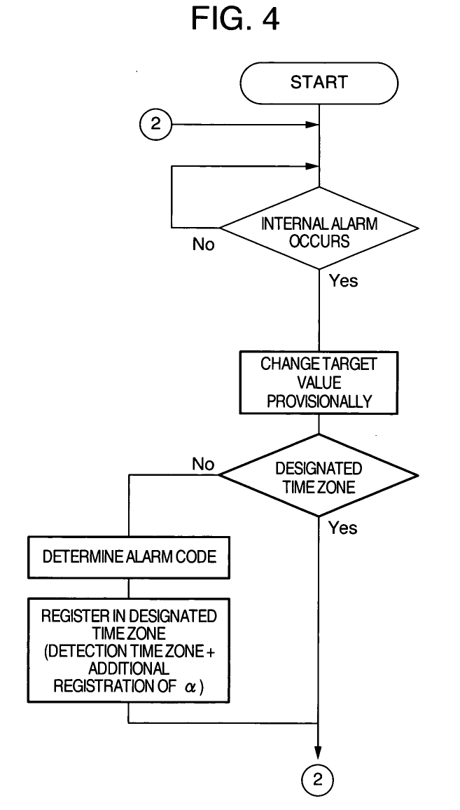

With reference to FIG. 4, a method of automatically setting a time zone when the learning is difficult to converge according to a third embodiment of the invention is explained. This embodiment assumes a system having a control mechanism in which an internal alarm is output by detecting the approach of an abnormal system state including an abnormal temperature of the hydrogen production unit. The internal alarm is to warn against the approach of an abnormal state for the internal process apart from the alarm issued to the user, and upon receipt thereof, an appropriate process is executed by, for example, switching the system control parameter.

Some internal alarm is issued due to the difference between the operation pattern and the actual load occurring, for example, in the case where the amount of the anode off-gas refluxing to the hydrogen production unit increases for an abnormally long time. In view of this, a method has been conceived in which upon issue of this type of alarm, the time range containing the time of occurrence is additionally registered as the aforementioned predetermined time zone during which the learning is difficult to converge.

The control flow is explained. Upon issue of the internal alarm, the target hydrogen production amount (target value) of the hydrogen production unit is first changed regardless of the learning pattern. The combustor temperature increase due to the increase in the return hydrogen amount, for example, can be avoided by reducing the hydrogen production amount. The change in the target value is provisional. The target value may be changed either only for a predetermined time from the time point when the change command is issued or may continue to be changed until the alarm is reset. After avoiding the approach of an abnormal state by changing the target value, it is determined whether the time point of alarm issue is included in a predetermined time zone when the learning is difficult to converge.

In the case where the predetermined time zone is already prevailing, it indicates that the alarm has occurred due to a large degree of load change and the approach to the abnormal condition could be accurately avoided by the particular alarm. In the case where the predetermined zone is not prevailing, in contrast, the setting of the predetermined time zone may be considered improper. In the latter case, the following process is executed. First, the code accompanying the internal alarm is checked to determine whether the particular alarm is issued by the difference between the operation pattern and the actual load pattern or not. The code accompanying the alarm is to classify the causes of generation of the alarm including the abnormal temperature of the combustor of the hydrogen production unit and other faults.

As an example, in the case where the temperature of the combustor is abnormal, an abnormal return hydrogen amount may be the cause, and therefore the alarm may have been issued due to the difference between the operation pattern and the actual load pattern. In the case where the fuel supply pressure is abnormal, on the other hand, the fuel supply system is considered abnormal, and therefore it is unlikely that the alarm is issued by the difference between the operation pattern and the actual load pattern. In this way, each code can be classified into two cases. In one case, we should change the time zone, while in the other case we should not. In the case where the determination is that the alarm has been issued by the difference between the operation pattern and the actual load pattern, a predetermined time interval from the issue of the alarm is additionally registered as the predetermined time zone.

The time interval additionally registered may be a predetermined time interval for one alarm issue or may continue to be registered in the predetermined time zone until the alarm is reset. As another alternative, the time interval may be changed in accordance with the alarm duration.

Although only the method of adding a predetermined time zone is explained in this embodiment, the registration can be automatically canceled by the method described with reference to FIG. 3 in the case where the time zone added is not proper.

In the method of automatically setting a time zone in which the learning is difficult to converge according to a third embodiment of the invention, upon determination that the internal alarm is issued due to the difference between the operation pattern set by learning and the load pattern, the predetermined time interval set based on the time point of alarm generation can be additionally registered in the predetermined time zone when the learning is difficult to converge. The registration of the time zone when the learning is difficult to converge can be additionally corrected in the stage of the internal alarm before generation of an abnormal state, and therefore the adaptation to different load patterns for different homes is safe and easy.

With reference to FIG. 5, the filter process for the detected load in the basic operation pattern setting of the fuel cell power generating system according to the present invention is explained. FIG. 5(a) is a schematic diagram for explaining a home-use power load pattern. The power consumption capable of being measured by a load detection means such as a current sensor is plotted along the ordinate, and the time elapsed in a day along the abscissa. The home-use power load pattern varies from one home to another. FIG. 5(a) schematically shows a unique change in which spike-like load changes of the order of one minute are superposed on the slow change in power consumption from the time of getting up to the time of going to bed.

From the viewpoint of the thermal response of the hydrogen production unit, it is difficult to follow the load change including the high frequency component such as the spike-like change. In considering the learning of the operation pattern for the hydrogen production unit, therefore, the learning control is desirably carried out for the load change pattern from which the high-frequency component is removed in advance. FIG. 5(b) is a schematic diagram showing the load pattern after the high-frequency component is removed by the filter process. The high-frequency component is smoothed and removed at predetermined time intervals. In FIG. 5, the load pattern is shown as an example of the load change (dotted line).

In the process of filtering the detected load according to the invention, the operation pattern is corrected by learning in accordance with the smoothed power load pattern. In the above-mentioned predetermined time zone when the learning is difficult to converge, therefore, the target operation pattern can be easily set, while in the time zone other than the predetermined time zone when the learning is difficult to converge, the operation of correction by learning having a high convergence characteristic can be performed.

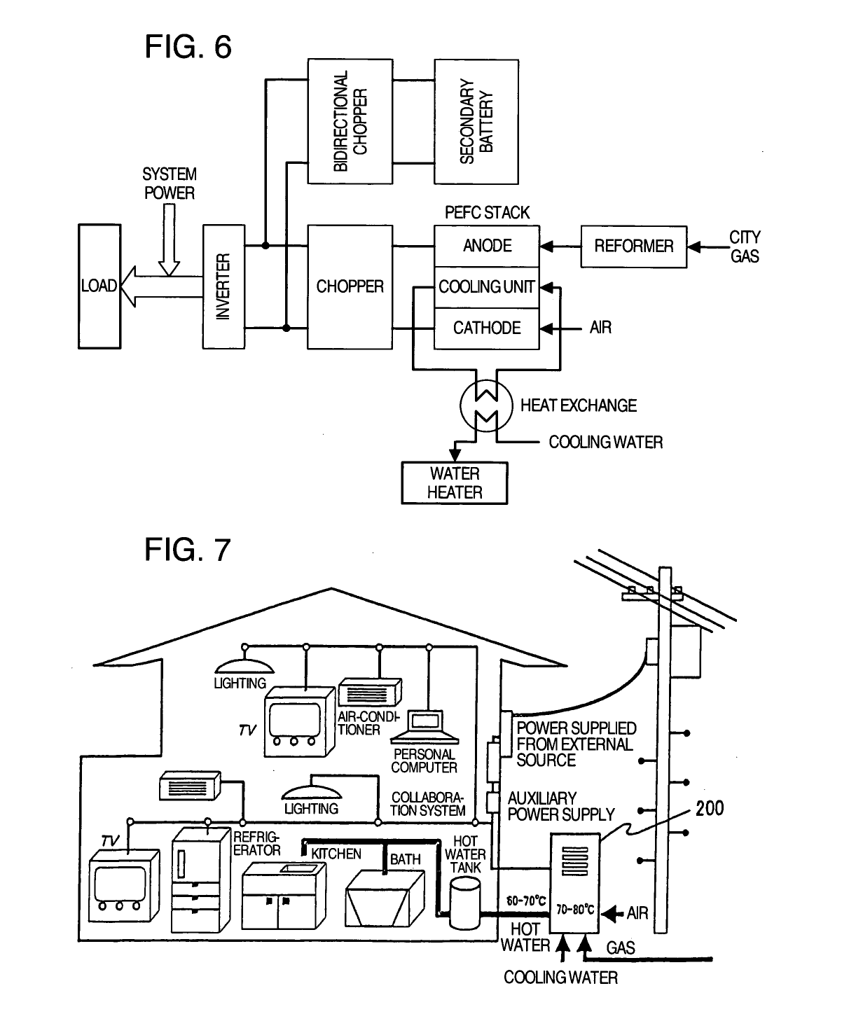

With reference to FIG. 6, an example of the system configuration is explained in which the power storage means such as a secondary battery operates in collaboration according to a fourth embodiment of the invention. The fuel cell (PEFC stack) shown in FIG. 6 is connected to an inverter through a chopper and operates to retrieve a predetermined current. The inverter is also connected with the power storage means such as the secondary battery through a bidirectional chopper. Any extraneous power which may be generated by the fuel cell over the load power detected by the load power detection means is stored, while in the case where power is in shortage, the current is discharged to accommodate the load power. With the response characteristic of the fuel cell system, it is generally difficult to follow the high-frequency component described in FIG. 5, and the high-frequency component of the power load pattern is accommodated by the discharge operation of the power storage means storing the extraneous power.

As long as the shift from the operation pattern learned is provisional, the power can be more securely accommodated by the charge/discharge operation of the power storage means through the concurrent use of the power storage means. In this way, the operation along the existing learning pattern is performed in other than the predetermined time zone. In the case where the shift from the learned operation pattern tends to undergoes a change depending on whether the home-coming time is early or late, on the other hand, the operation pattern is better changed to secure stability and efficiency. Although the operation pattern is changed during the predetermined time zone as described above, the overage or shortage of the supply power which occurs with respect to the load power can be similarly accommodated by the power storage means.

In the example of the system configuration in which the power storage means such as the secondary battery operates in collaboration according to the fourth embodiment of the invention, the entire power corresponding to the high-frequency component can be supplied by the secondary battery without purchasing the system power even after the detected load is filtered to learn the operation pattern, and therefore power can be generated efficiently.

FIG. 7 shows an example of application of the fuel cell power generating system according to the invention as a stationary distribution power supply arranged in each home. Numeral 200 designates a stationary distribution power supply including, at least as a part thereof, the cell water heating power generating system according to the invention.

In this system, the hydrogen production unit produces hydrogen from materials including the gas and air supplied from an external source and the ion exchange water produced from the pure water or the running water generated as the result of fuel cell power generation. The natural gas or the city gas containing methane as a main component can be used as the material gas. The propane gas or other fuel can alternatively be supplied in a cylinder. In the case where the city gas is used, the sulfur component contained in the odorant is known to poison the catalyst, and therefore the city gas is supplied to a catalyst reactor through a desulfurizing agent.

The advantage of using the fuel cell as the stationary distribution power supply lies in that not only power is generated but also hot water can be obtained from the exhaust heat of the fuel cell. In the case of a solid polymer fuel cell, the temperature reaches about 70° C. to 80° C. at the time of power generation, and the internal temperature of the fuel cell is adjusted using the cooling water or the like. Hot water can be obtained by cooling and recovering the extraneous heat generated by the reaction and internal resistance of the fuel cell. In the case where the water supplied from an external source is directly used to cool the fuel cell, however, the impurities contained in the water may have an adverse effect on the fuel cell. In such a case, therefore, the water supplied from the external source is heated indirectly using a means having the heat exchange function.

The hot water increased in temperature reaches about 50° C. to 60° C., for example, and therefore, if stored in a hot water tank, can be used for the kitchen, bathroom and toilet without a water heater. In addition, the power obtained by the power generation is used to drive various home electric appliances with the power supplied from the external source. Thus, the amount of power supplied from the external source can be reduced. As far as the power generation capacity is sufficiently large, power can of course be supplied without the external power supply.

In the case where the temperature of the water supplied from an external source is low and not sufficiently increased, or in the case where the water temperature in the hot water tank decreases, an independent heating means can be provided. The heating means is adapted to burn part of the material gas supplied from an external source thereby to increase the water temperature. By the feedback control to regulate the temperature or the flow speed of the hot water, the supplied water can be increased to and maintained at a predetermined temperature. A similar system can also be configured in combination with a commercially available gas reheater.

In an application of the fuel cell power generating system according to the invention to a home-use cogeneration system, the learning operation pattern is determined in advance, and during the time zone when the learning is difficult to converge, the operation pattern is switched in accordance with the actual load change. Therefore, the capability of following the load change unique to a home-use load can be steadily secured.

In the fuel cell power generating system according to the invention, the time zone when the operation pattern can be obtained with a high convergence characteristic and the other time zone are set in advance. In the case where a significant difference develops between the target operation pattern and the actual load pattern, therefore, it is possible to accurately determine whether the operation is to be continued without changing the basic operation pattern or the operation is to be changed in accordance with the actual load pattern. As a result, the operation can be easily corrected in accordance with the complicated load change of home-use appliances or the like, based on the scheduled operation having a predetermined operation pattern.

### INDUSTRIAL APPLICABILITY

The present invention is suitably used for the various types of fuel cells or especially the fuel cell as a home-use power supply.

1. A fuel cell power generating system comprising a fuel cell, a power conversion means for controlling and retrieving the current from the fuel cell, a hydrogen production unit for supplying hydrogen to the fuel cell, a load detection means for detecting the required power generation amount for the fuel cell, and a means for controlling at least one of the hydrogen production amount of the hydrogen production unit and the power output amount of the fuel cell during the time zone in accordance with a predetermined operation pattern in daily cycles, characterized in that a specified time zone when a load change is expected is preset in the operation pattern, and based on the required power generation amount detected by the load detection means, the hydrogen production amount during the specified time zone is switched in priority over the operation pattern.

2. A fuel cell power generating system as set forth in claim 1, wherein in the case where the operation pattern is different, by a predetermined value or more, from the pattern requested from the load detected by the load detection means, the difference is learned and reflected in the operation pattern for the next and subsequent days.

3. A fuel cell power generating system as set forth in claim 1, characterized in that the specified time zone is a predetermined time zone when the learning is difficult to converge.

4. A fuel cell power generating system as set forth in claim 3, characterized in that the predetermined time zone when the learning is difficult to converge is preset in daily cycles.

5. A fuel cell power generating system as set forth in claim 3, characterized in that the weight of learning is varied between the time zone when the learning is difficult to converge and the other time zone thereby to correct by learning the operation pattern in daily cycles.

6. A fuel cell power generating system as set forth in any one of claims 1 to 5, characterized in that the frequency at which the difference occurs between the operation pattern and the load pattern is calculated at predetermined time intervals, and by referring to the frequency of occurrence, the set range of the predetermined time zone when the learning is difficult to converge is additionally registered or the registration thereof is canceled.

7. A fuel cell power generating system as set forth in any one of claims 1 to 6, comprising a control mechanism for detecting the approach of an abnormal system state of the hydrogen production unit and outputting an internal alarm, characterized in that upon determination that the alarm is generated by the difference between the operation pattern and the load pattern, a predetermined time interval set with reference to the time point of alarm generation is additionally registered in the predetermined time zone when the learning is difficult to converge.

8. A fuel cell power generating system as set forth in any one of claims 1 to 7, characterized in that the required power generation amount is set by smoothing, at predetermined time intervals, the high-frequency component of the power load pattern detected by the load detection means.

9. A fuel cell power generating system as set forth in any one of claims 1 to 8, comprising a power storage means such as a secondary battery collaborating with the fuel cell, characterized in that the high-frequency component of the power load pattern detected by the load detection means is accommodated by the discharge or storage of power by the power storage means.

10. A fuel cell power generating system characterized by comprising a fuel cell, a power conversion means for controlling and retrieving the current from the fuel cell, a hydrogen production unit for supplying hydrogen to the fuel cell, a load detection means for detecting the required power generation amount for the fuel cell and a means for selecting a predetermined operation pattern and thereby controlling at least one of the hydrogen production amount of the hydrogen production unit and the power output amount of the fuel cell during a predetermined time zone.

11. A fuel cell power generating system as set forth in claim 10, characterized in that the operation pattern is selected during a specified time zone when a preset load change is predicted.
